(19) United States
(12) Patent Application Publication
(10) Pub. No.: US 2018/0213058 A1
(43) Pub. Date: Jul. 26, 2018

(54) DYNAMIC ADJUSTMENT OF USER PROFILES FOR BUNDLED APPLICATIONS

(71) Applicant: INTERDIGITAL TECHNOLOGY CORPORATION, Wilmington, DE (US)

(72) Inventors: Shoshana Loeb, Philadelphia, PA (US); Kuo-Chu Lee, Princeton Junction, NJ (US); Zijun Yao, North Arlington, NJ (US)

(73) Assignee: INTERDIGITAL TECHNOLOGY CORPORATION, Wilmington, DE (US)

(21) Appl. No.: 15/503,278

(22) PCT Filed: Aug. 11, 2015
(86) PCT No.: PCT/US2015/044604

§ 371 Date: Feb. 10, 2017

Related U.S. Application Data
(60) Provisional application No. 62/035,754, filed on Aug. 11, 2014.

(51) Int. Cl. H04L 29/08

(52) U.S. Cl. CPC H04L 67/306; H04L 67/22

(57) ABSTRACT

A method and apparatus for dynamic adjustment of user profiles for a bundled application is disclosed. Multi-dimensional characteristic attributes of a plurality of players may be tracked and utilized to improve player experience, player retention, and detect abnormal behavior in game play. Player performance and interest may be assessed in real-time. Game independent characteristic attributes are defined for player profiles and are used to adjust a player's experience or preference level based on gaming results such as win-loss scores. Characteristic weights for a player's characteristic attributes are also defined. Methods and apparatus to select game sessions and players with similar interests or experiences are also disclosed. Methods for detecting abnormal patterns in game session behavior are also disclosed. Methods and apparatus for allowing users to opt out of the calibrations process are also disclosed.

### CROSS REFERENCE TO RELATED APPLICATION

This application is the U.S. National Stage, under 35 U.S.C. § 371, of International Application No. PCT/US2015/044604 filed Aug. 11, 2015, which claims the benefit of U.S. provisional application No. 62/035,754 filed Aug. 11, 2014, the content of which is hereby incorporated by reference herein.

### BACKGROUND

User profiling is a process for collecting, analyzing and categorizing customer behaviors for marketing and customer relationship management. in user profiling, a specific business goal may be applied to the analysis. A user profile may include personal, demographic, and/or application specific behavior data. Methods such as data analysis and mining may be used to analyze massive amounts of data collected from popular applications (“apps”) such as browsers, search engines, and shopping sites to learn and identify clustering and correlation models of user behavior and preference patterns. These learned models of patterns and correlations may be used, for example, to improve personalized user experiences in search, advertisements, product recommendations and customer support.

### SUMMARY

A method and apparatus for dynamic adjustment of user profiles for bundled applications is disclosed. Multi-dimensional characteristic attributes of a plurality of players may be tracked and utilized to improve player experience, facilitate player retention, and/or detect abnormal behavior in game play. Player performance and/or interest may be assessed in real-time. Game independent characteristic attributes are described for player profiles and may be used to adjust a player's experience or preference level based on gaming results, such as win-loss scores. Characteristic weights for a player's characteristic attributes are discussed. Methods and apparatus to select game sessions and players with similar interests or experiences are also discussed. Methods for detecting abnormal patterns in game session behavior are likewise discussed. Methods and apparatus for allowing users to opt out of the calibrations process are also discussed.

### BRIEF DESCRIPTION OF THE DRAWINGS

A more detailed understanding may be had from the following description, given by way of example in conjunction with the accompanying drawings wherein:

FIG. 1A is a system diagram of an example communications system in which one or more disclosed embodiments may be implemented;

FIG. 1B is a system diagram of an example wireless transmit/receive unit (WTRU) that may be used within the communications system illustrated in FIG. 1A;

FIG. 1C is a system diagram of an example radio access network and an example core network that may be used within the communications system illustrated in FIG. 1A;

FIG. 1D is a system diagram of an example communications system in which one or more disclosed embodiments may be implemented;

FIG. 2 is a diagram of an example context aware cross game player skill profiling system;

FIG. 3 is flow-diagram of an example method for skill vector (SV) projection, ranking and win-loss calibration;

FIG. 4 is a flow-diagram of an example method for iterative skill vector calibration;

FIG. 5 is a matrix illustrating profiling of an example skill vector;

FIG. 6 is a matrix illustrating calibration of example skill vectors;

FIG. 7 is a diagram of an example model of the profiling system; and

FIG. 8 is a diagram of an example data cube for game metrics, session context and user profiles.

### DETAILED DESCRIPTION

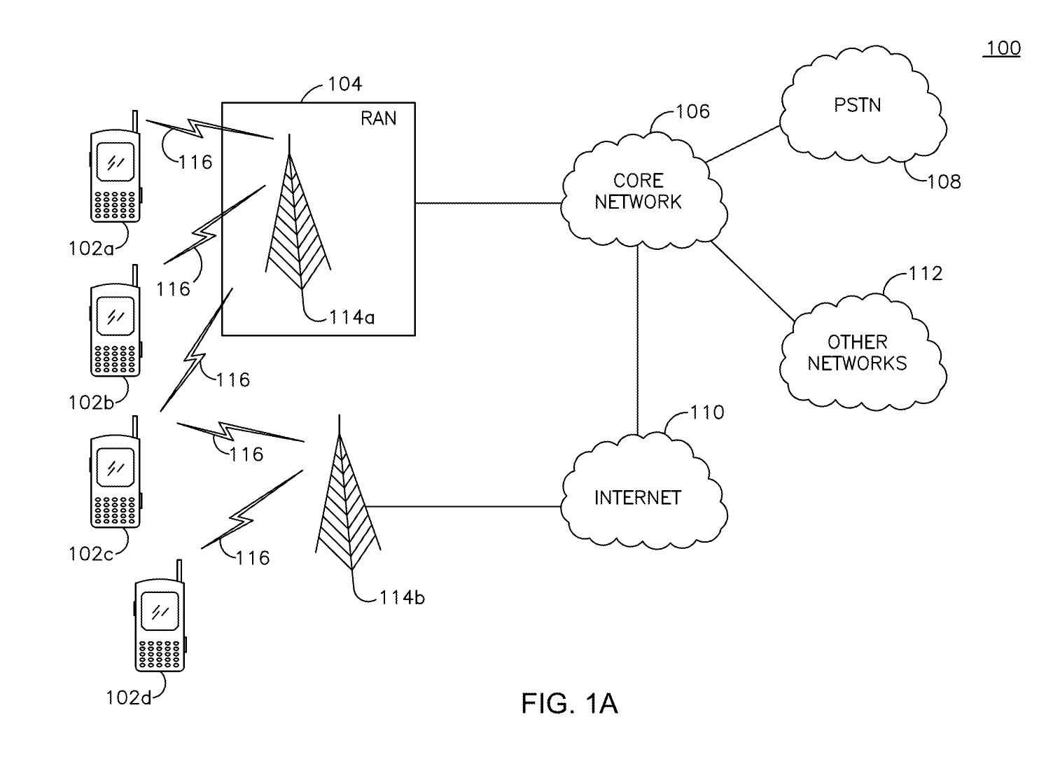

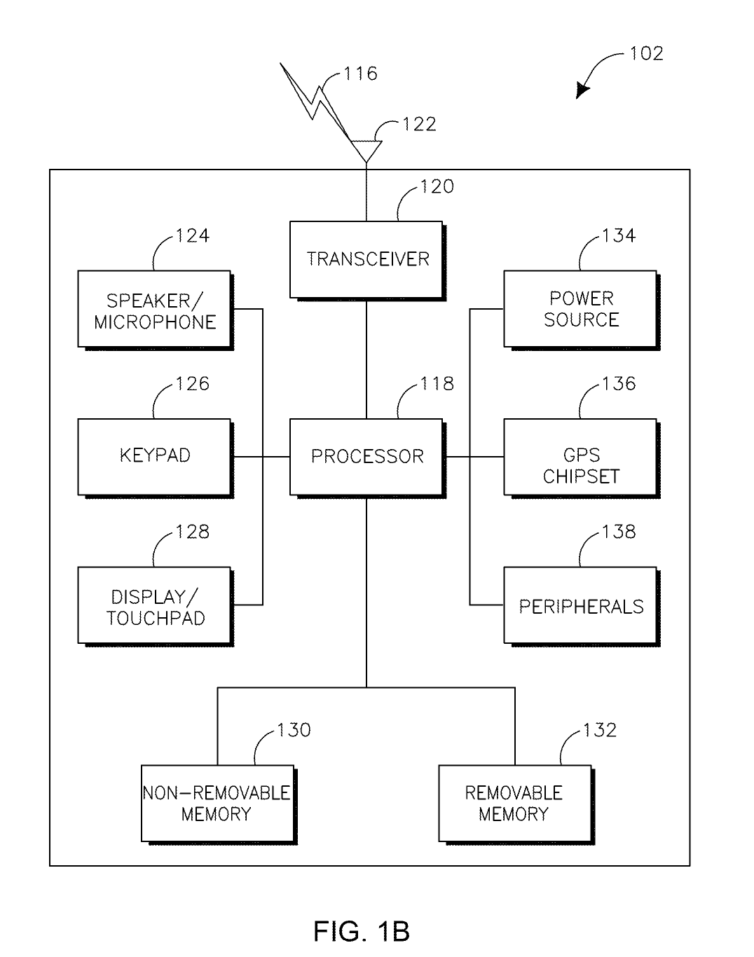

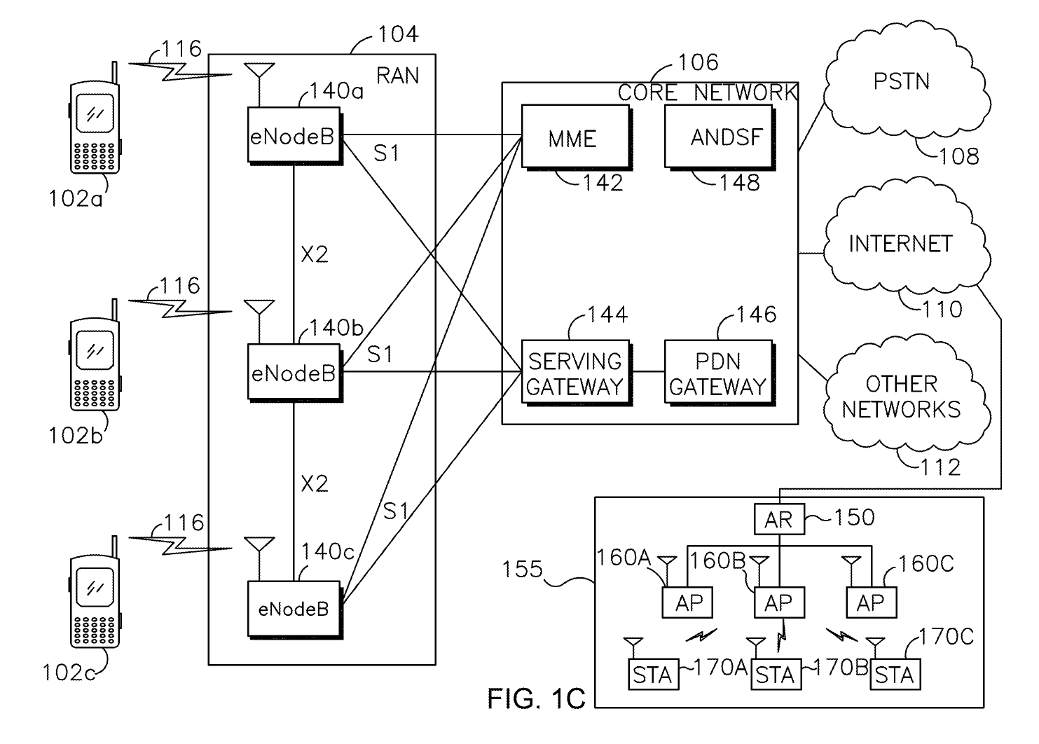

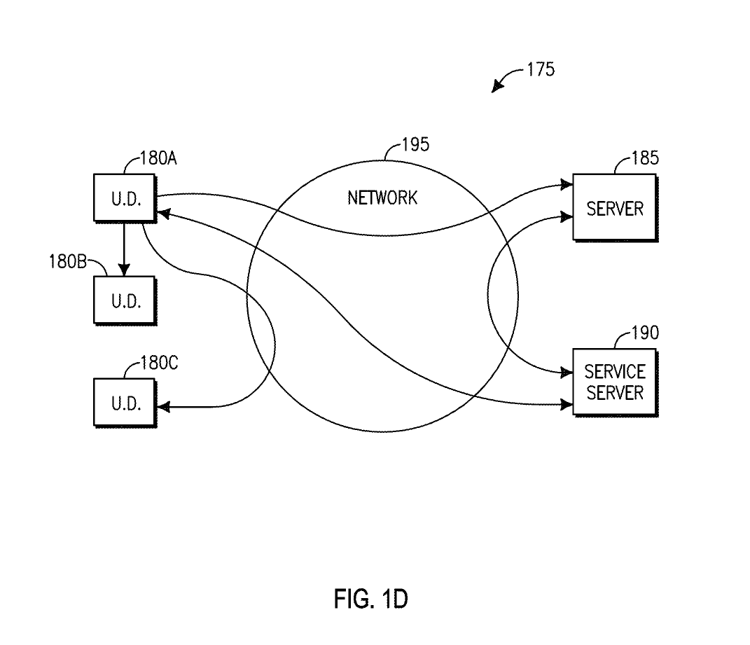

FIG. 1A is a diagram of an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), and the like.

As shown in FIG. 1A, the communications system 100 may include wireless transmit/receive units (WTRUs) 102a, 102b, 102c, 102d, a radio access network (RAN) 104, a core network 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d may be configured to transmit and/or receive wireless signals and may include user equipment (UE), a mobile station, a fixed or mobile subscriber unit, a pager, a cellular telephone, a personal digital assistant (PDA), a smartphone, a laptop, a netbook, a personal computer, a wireless sensor, consumer electronics, and the like.

The communications systems 100 may also include a base station 114a and a base station 114b. Each of the base stations 114a, 114b may be any type of device configured to wirelessly interface with at least one of the WTRUs 102a, 102b, 102c, 102d to facilitate access to one or more communication networks, such as the core network 106, the Internet 110, and/or the other networks 112. By way of example, the base stations 114a, 114b may be a base transceiver station (BTS), a Node-B, an eNode B, a Home Node B, a Home eNode B, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, etc. The base station 114a and/or the base station 114b may be configured to transmit and/or receive wireless signals within a particular geographic region, which may be referred to as a cell (not shown). The cell may further be divided into cell sectors. For example, the cell associated with the base station 114a may be divided into three sectors. Thus, in one embodiment, the base station 114a may include three transceivers, i.e., one for each sector of the cell. In another embodiment, the base station 114a may employ multiple-input multiple-output (MIMO) technology and, therefore, may utilize multiple transceivers for each sector of the cell.

The base stations 114a, 114b may communicate with one or more of the WTRUs 102a, 102b, 102c, 102d over an air interface 116, which may be any suitable wireless communication link (e.g., radio frequency (RF), microwave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In another embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A).

In other embodiments, the base station 114a and the WTRUs 102a, 102b, 102c may implement radio technologies such as IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, and the like. In one embodiment, the base station 114b and the WTRUs 102c, 102d may implement a radio technology such as IEEE 802.11 to establish a wireless local area network (WLAN). In another embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, etc.) to establish a picocell or femtocell. As shown in FIG. 1A, the base station 114b may have a direct connection to the Internet 110. Thus, the base station 114b may not be required to access the Internet 110 via the core network 106.

The RAN 104 may be in communication with the core network 106, which may be any type of network configured to provide voice, data, applications, and/or voice over internet protocol (VoIP) services to one or more of the WTRUs 102a, 102b, 102c, 102d. For example, the core network 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the core network 106 may be in direct or indirect communication with other RANs that employ the same RAT as the RAN 104 or a different RAT. For example, in addition to being connected to the RAN 104, which may be utilizing an E-UTRA radio technology, the core network 106 may also be in communication with another RAN (not shown) employing a GSM radio technology.

The core network 106 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and the internet protocol (IP) in the TCP/IP internet protocol suite. The networks 112 may include wired or wireless communications networks owned and/or operated by other service providers. For example, the networks 112 may include another core network connected to one or more RANs, which may employ the same RAT as the RAN 104 or a different RAT.

Some or all of the WTRUs 102a, 102b, 102c, 102d in the communications system 100 may include multi-mode capabilities, i.e., the WTRUs 102a, 102b, 102c, 102d may include multiple transceivers for communicating with different wireless networks over different wireless links. For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram of an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and other peripherals 138. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In another embodiment, the transmit/receive element 122 may be an emitter/detector configured to transmit and/or receive IR, UV, or visible light signals, for example. In yet another embodiment, the transmit/receive element 122 may be configured to transmit and receive both RF and light signals. It will be appreciated that the transmit/receive element 122 may be configured to transmit and/or receive any combination of wireless signals.

In addition, although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as UTRA and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

FIG. 1C is a system diagram of the RAN 104 and the core network 106 according to an embodiment. As noted above, the RAN 104 may employ an E-UTRA radio technology to communicate with the WTRUs 102a, 102b, 102c over the air interface 116. The RAN 104 may also be in communication with the core network 106.

The RAN 104 may include eNode-Bs 140a, 140b, 140c, though it will be appreciated that the RAN 104 may include any number of eNode-Bs while remaining consistent with an embodiment. The eNode-Bs 140a, 140b, 140c may each include one or more transceivers for communicating with the WTRUs 102a, 102b, 102c over the air interface 116. In one embodiment, the eNode-Bs 140a, 140b, 140c may implement MIMO technology. Thus, the eNode-B 140a, for example, may use multiple antennas to transmit wireless signals to, and receive wireless signals from, the WTRU 102a.

Each of the eNode-Bs 140a, 140b, 140c may be associated with a particular cell (not shown) and may be configured to handle radio resource management decisions, handover decisions, scheduling of users in the uplink and/or downlink, and the like. As shown in FIG. 1C, the eNode-Bs 140a, 140b, 140c may communicate with one another over an X2 interface.

The core network 106 shown in FIG. 1C may include a mobility management entity gateway (MME) 142, a serving gateway 144, and a packet data network (PDN) gateway 146. While each of the foregoing elements are depicted as part of the core network 106, it will be appreciated that any one of these elements may be owned and/or operated by an entity other than the core network operator.

The MME 142 may be connected to each of the eNode-Bs 140a, 140b, 140c in the RAN 104 via an S1 interface and may serve as a control node. For example, the MME 142 may be responsible for authenticating users of the WTRUs 102a, 102b, 102c, bearer activation/deactivation, selecting a particular serving gateway during an initial attach of the WTRUs 102a, 102b, 102c, and the like. The MME 142 may also provide a control plane function for switching between the RAN 104 and other RANs (not shown) that employ other radio technologies, such as GSM or WCDMA.

The serving gateway 144 may be connected to each of the eNode Bs 140a, 140b, 140c in the RAN 104 via the S1 interface. The serving gateway 144 may generally route and forward user data packets to/from the WTRUs 102a, 102b, 102c. The serving gateway 144 may also perform other functions, such as anchoring user planes during inter-eNode B handovers, triggering paging when downlink data is available for the WTRUs 102a, 102b, 102c, managing and storing contexts of the WTRUs 102a, 102b, 102c, and the like.

The serving gateway 144 may also be connected to the PDN gateway 146, which may provide the WTRUs 102a, 102b, 102c with access to packet-switched networks, such as the Internet 110, to facilitate communications between the WTRUs 102a, 102b, 102c and IP-enabled devices.

The core network 106 may facilitate communications with other networks. For example, the core network 106 may provide the WTRUs 102a, 102b, 102c with access to circuit-switched networks, such as the PSTN 108, to facilitate communications between the WTRUs 102a, 102b, 102c and traditional land-line communications devices. For example, the core network 106 may include, or may communicate with, an IP gateway (e.g., an IP multimedia subsystem (IMS) server) that serves as an interface between the core network 106 and the PSTN 108. In addition, the core network 106 may provide the WTRUs 102a, 102b, 102c with access to the networks 112, which may include other wired or wireless networks that are owned and/or operated by other service providers.

Other network 112 may further be connected to an IEEE 802.11 based wireless local area network (WLAN) 160. The WLAN 160 may include an access router 165. The access router may contain gateway functionality. The access router 165 may be in communication with a plurality of access points (APs) 170a, 170b. The communication between access router 165 and APs 170a, 170b may be via wired Ethernet (IEEE 802.3 standards), or any type of wireless communication protocol. AP 170a is in wireless communication over an air interface with WTRU 102d.

FIG. 1D is a system diagram of an example communications system 175 in which one or more disclosed embodiments may be implemented. In some embodiments, communications system 175 may be implemented using all or a portion of system 100 as shown and described with respect to FIG. 1A.

User device 180a, server 185, and/or service server 190 may communicate over communications network 195. These communications may be wireless, wired, or any combination of wireless and wired. Communications network 195 may include the internet 110, core network 106, other networks 112, or any other suitable communications network or combination of communications networks.

User device 180a may include a WTRU (such as WTRU 102a), or any suitable user computing and/or communications device such as a desktop computer, web appliance, interactive television (ITV) device, gaming console (such as Microsoft XBOX™ or Sony Playstation™) or the like. User device 180a and/or applications executing on user device 180a may generate events such as mouse clicks, keyboard strokes, and the like. These events may be processed by user device 180a and/or may be transmitted to another device such as server 185 or service server 190.

Server 185 may include a web server, application server, data server, or any combination of these or other types of servers. Server 185 may include any suitable server device such as a server computer, personal computer, or the like. Server 185 may host applications accessible to user device 185a. For example, server 185 may include a gaming server hosting a massively multiplayer online game (MMOG), an email server, a web server hosting a website such as a social media website or blog, or other types of servers typically accessible by a user device over a computer communications network.

User device 180a may access server 185 over computer communications network 175 to interact with services that it provides. For example, user device 180a may access a game server hosted on server 185 to participate in a multiplayer online game. Access of server 185 by user device 180a may be via a client application executing on user device 180a or any other suitable mechanism. In some cases, the server 185 may receive events from user device 180a, or may send events to user device 180a. For example, the server 185 may send an event to user device 180a indicating that additional in-game resources are required for continued play.

Service server 190 may include a web server, application server, data server, or any combination of these or other types of servers hosted on a server device. Service server 190 may include any suitable server device such as a server computer, personal computer, or the like. Service server 190 may be configured to communicate with server 185, for example, over network 195 or any other suitable communications medium. Service server may be co-located with, combined with, or in direct communication with server 185.

Service server 190 may communicate with server 185 to provide services, such as third party services, to users of server 185. For example, a subscriber to a game hosted on server 185 may access server 185 from user device 180A and may subscribe to third party services for the game which are hosted on service server 190.

Service server 190 may be configured to receive and/or intercept events transmitted between user device 180a and server 185. For example, in some embodiments server 185 and service server 190 may be configured such that server 185 may send an event destined for user device 180a instead or additionally to service server 190, and service server 190 may send the event or another event, signal, or message to device 180a. For instance, in a case where server 185 includes a game server, server 185 may send an event to service server 190 indicating a requirement of a user of user device 180a, and server 190 may send the event or another signal or message to device 180a indicating that a resource is available to acquire the requirement. In some embodiments, service server 190 may only forward the event to device 180a under certain conditions, such as based on a user preference and/or context information relating to the user of device 180a.

In some embodiments, the functions of service server 190 and server 185 may be implemented using the same device, or across a number of additional devices.

In some embodiments, user devices 180b and 180c may communicate with server 185 and/or service server 190 via user device 180a. For example, user device 180a may forward a notification message from service server 190 to user device 180b via a peer to peer connection and may forward a notification message from service server 190 to user device 180c via network 195. In some embodiments, user devices 180a, 180b, and 180c may form a network, such as a peer-to-peer network, and such network may have a mesh topology, a star topology using user device 180a as a coordinating node, or any other suitable topology. In such embodiments, the peer-to-peer network may operate independently of server 185 and/or service server 190, and may incorporate functionality that otherwise would be hosted by server 185 and/or service server 190, such as functionality described herein.

Everything that follows may, but is not required to be, employed and/or implemented using one or more, or part of one or more of the example systems discussed above.

Social networking, location services, and mobile applications may enable collection and analysis of location or social context associated with real-time user interactions inside mobile applications and games. In-app and in-game user interaction data may provide a source of information for real time user experiences or customer retention applications. For example, mobile app and game developers may use analytic tools and data mining processes to collect and analyze large amounts of user interaction data to support in-app advertising or shopping recommendations, or to improve game design.

Due to the diversity of game types and user interactions within games, user behavior may differ across various types of games. User characteristics may be analyzed and may be separated into several intrinsic characteristic attributes. For example, players' game playing characteristics may be divided into Achievement, Social and Immersion categories. Players' game play skill may be divided into components such as Perceptual-Motor, Cognitive, Problem-Solving, Information use, Persistence, and Human-Human Interaction for multiple different games. Such player behavior characteristics may be used to gain insight for creative game design and as a foundation for game behavior analysis.

Current data analysis and data mining methodologies for analyzing user behavior to improve user experiences and customer retention may be useful for user profiling for individual games or applications, however, such current methodologies may fall short in dealing with a plurality of mobile applications and games. For example, data collection and analysis may be an expensive and elaborate process. Data mining may call for the use of experts to analyze and interpret data mining results. This may not be desirable for small and medium size mobile app and game developers.

Data modeling may also be a complex process. For example, the syntax and semantics of data collected from each individual game session may be different. Standard descriptors to represent similar behaviors or actions across multiple games do not exist. For example, walking, running, and jumping may be coded differently from game to game. There may also be a diversity of skill set requirements across various mobile apps or games. For example, the required skill sets for one game session may be different from the skill sets required for another. For instance, some sessions may require good jumping skills, whereas others may require a high degree of physics knowledge, and others may require high shooting accuracy.

Player compatibility may also be an issue across various mobile applications or games. Players' interests and skills may be incompatible for a specific game session. For example, a player interested and skilled in exploration games, e.g., investigating a secret treasure found in a game, who is placed in a game session that requires battle skills and is surrounded by other players with exceptional battle skills, may be unlikely to have the chance to explore and may be likely to have a sub-optimal experience of the game session. Such mismatches of game session and player preference and skill may be undesirable. Buying and installing an app, selecting a session to join and waiting for other players to play may also be time consuming and costly.

The dynamics of player behavior may also create an issue across various mobile applications or games. For example, players gain experience and improve their skills over time. It may be desirable to track players' individual learning curves and to use the tracked information to take remedial action in order to retain the players within the game bundle or within a game hosting service which provides multiple game bundles.

Various approaches for analyzing user behavior and for improving user experiences and customer retention across multiple mobile applications and games are further discussed herein. In one embodiment, an iterative game and player profiling system may be used to track a set of multi-dimensional characteristic attributes of a set of players to improve player experience, improve player retention, or detect abnormal behavior, among other features.

A game and player profiling system may be configured to automate the profiling process to assess player performance and characteristics in real-time and may be configured to minimize the delay and/or costs of off-line data analysis and data mining.

Such game and player profiling systems may be configured to define game-independent intrinsic characteristic attributes in order to profile a player, and to adjust, for example, the player's experience, preference level, or percentage ranking for each attribute. The adjustment may be based for example on gaming results, such as win-loss scores against other players, or artificial intelligence (AI) from multiple types of games.

Such game and player profiling systems may be configured to define various prospective game session profiles based on a weighting of a player's intrinsic characteristic attributes. The weighting of each attribute may indicate a relative importance or frequency of usages of each characteristic attribute that may affect the overall performance or outcome, e.g., win-loss scores, of each game session.

Such game and player profiling systems may be configured to select game sessions and players having similar interest and experience or preference levels based on multi-dimensional game session and player profiles.

Such game and player profiling systems may utilize rule engines to support customizable decision policies for selection, calibration, and usage of characteristic attributes to identify and choose remedial actions which may improve player experience, increase customer retention, and detect abnormal patterns or behaviors.

Such game and player profiling systems may also use skill calibration to help players find suitable opponents, e.g., suitable human players or computer opponents having suitable levels of AI. This may facilitate customer retention by providing a fair win-loss rate. Such game and player profiling systems may monitor various real-time profiling metrics to track the results and provide detailed feedback to players in real-time.

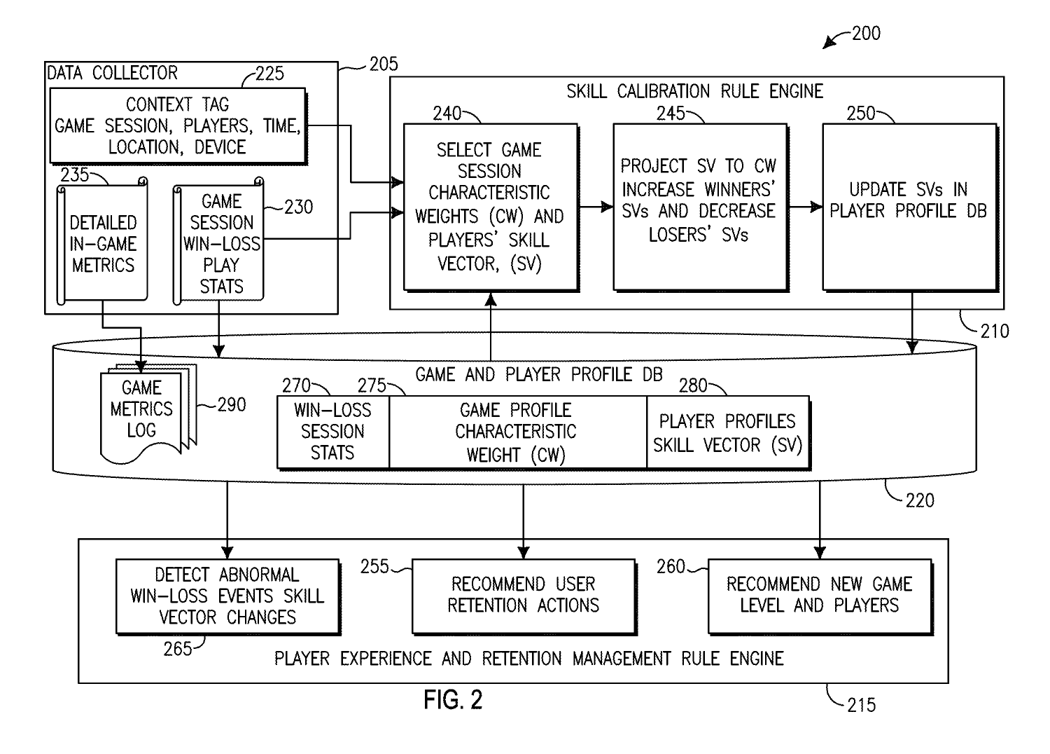

FIG. 2 is a diagram of an example context aware cross game player skill profiling system 200. In the example shown in FIG. 2, the context aware cross game player skill profiling system 200 may include a data collector 205, a skill calibration rule engine 210, a player experience and retention management rule engine 215, and a game and player data storage repository 220.

The data collector 205 may be configured to receive data and to separate the data into, for example, context tags, session win-loss play statistics 230, and detailed in-game metrics 235. The data collector 205 may also be configured to store and/or communicate the data to other parts of the system.

The data collector may include a context tag sub module 225. The context tag sub module may contain metadata about the game session, players, time, location, and device. For example, a context tag for an example session 3 of an example multi-player shoot game, BattlefieldX, may include a Game Session Descriptor, Game Session Win-Loss Play Records, and Game metrics.

The Game Session Descriptor may be defined, for example, as in Table 1, below:

TABLE 1
Example Game Session Win-Loss Play Records Matrix

Game Descriptor : {GameID: BattlefieldX, GameType = FPS,
SessionID = 3, Characteristic Weight, CW = {Reaction:0.4, Accuracy:
0.4, Strategy:0.1, Persistency:0.1};
Player.Env: Pi.env = {Anonymous_ID, Time: yy:mm:dd h:m:s,
Location:{Lng, Lat}, Device:iPhone};
Players in the session: {P1.ID, P2.ID, . . ., Pi.ID} //set of Players'
anonymous ID;
Players' Skill Vector: SV = {P1.SV , P2.SV, . . . , Pi.SV} where,
Pi.SV is skill vector for the player i.

The player skill vector for this example may be defined as follows: [Reaction: 0.8, Accuracy: 0.8, Strategy: 0.5, Persistency: 0.5].

The example player skill vector provided above includes four characteristics of a player: (1) reaction time, (2) shooting accuracy, (3) strategy or knowledge level of the game, and (4) persistence or how long the user needs to play the session. The value for each characteristic in the skill vector may range from 0 to 1. The skill vector for a player may be assessed initially by opposing the player using an AI bot in a single player game. If the user plays more than one session, the skill vector may be updated based on the win-loss records of play with other AI bots or other players having different skill vectors. It is noted that these characteristics are exemplary, and that any suitable characteristics may be used.

Session win-loss play statistics 230 may include win-loss records modeled as competition outcome statistics collected within a session. For example, the session play record may be mapped to a matrix as shown in Table 2, below.

TABLE 2
Example Game Session Win-Loss Play Records Matrix

| | Unexpected Win-Loss | | | |
|---|---|---|---|---|
| | P1 | P2 | P3 | P4 |
| P1 | | 0.4 | −0.3 | |
| P2 | −0.4 | | 0.25 | −0.1 |
| P3 | 0.3 | −0.25 | | 0.4 |
| P4 | | 0.1 | −0.4 | |

Prorating factor (e.g., (P1.score-P2.score)/(P1.score + P2.score) or 1-P1.score(loser)/P2.score(Winner), etc . . . Max: 0.5, Min: −0.5)

Each entry in the matrix may be a ratio ranging between −1 and 1, which may be used to indicate relative performance differences between players and/or AI Bots (P1, P2, P3, and P4 in the example of Table 2). The prorating factor, R, may be defined as (P1.score−P2_score)/(P2.score+P1.score), as (P1.hit−P2.hit)/(P1.hit+P2.hit), as (P1.treasureCount−P2.treasureCount)/(P1.treasureCount+P2.treasureCount), or in another suitable manner.

The range of the prorating factor may affect an amount of adjustment for unexpected win-loss scores. The range may be capped, e.g. between −0.5 to 0.5, as shown in the example game session Win-Loss Play Records Matrix in Table 2.

Game metrics 235 may include a set of game specific data. For example, game metrics 235 may be defined as:
{game ID, game session IDs, players' IDs, players' device, players' dossiers, Players' in-game performance data, Players' in-game purchasing data, Players' in-game social data, Players' in-game quest data}.
   Such metrics may be stored in a game metrics log 290, which may reside in game and player data storage repository 220.

The skill calibration rule engine 210 may include a game session characteristic weight and player skill vector selection module 240, a skill vector calibration module 245 and a profile update module 250.

The game session characteristic weight and player skill vector selection module 240 may include a set of rules which filter data collected from the data collector and may bind the input data stream to retrieve a game session's characteristic weights (CWs) and player's skill vectors (SVs) from the database.

The skill vector calibration module 245 may be configured to calculate an expected score (ES), based on SVs and corresponding CWs, (e.g., by projecting ES=SV·CW). A player's expected score may be used to rank the player prior to a game session. If a player having a higher ES loses to a player having a lower ES, the skill vectors of the winner and loser may be adjusted accordingly. The system may support many kinds of adjustments or calibration policies. For example, the following example rules may be used to calibrate the skill vector for each player based on a prorate factor, R, where, for example, Player X (Pₓ) with a lower Expected Skill Vector (Pₓ.ES) unexpectedly obtains a higher performance score (Pₓ.score) than a set of other Players (Pᵢ.score) with higher Expected Skill Vectors (Pᵢ.ES) and Player Y (P_{y}) with higher Expected Skill Vector obtains a lower score than a set of player Pⱼ with lower Expected Skill Vectors:

If ((Pₓ.ES<Pᵢ.ES) and (Pₓ.score>Pᵢ.score)) then, Pₓ.SV=Pₓ.SV+R*SUM(Pᵢ.ES−Pₓ.ES)·CW)/M for i=1, . . . , M and i≠X

If ((P_{y}.ES>Pⱼ.ES) and (P_{y}.score<Pⱼ.score)) P_{y}.SV=P_{y}.SV+R*SUM(P_{y}.ES−Pⱼ.ES)·CW)/N, For j=1, . . . N and j≠Y. The calibration rule increases the Skill Vector of Player X, Pₓ, by adding the differences in expected scores between Pₓ and all the players, Pᵢ who lost to Pₓ (i.e., R*SUM((Pᵢ.ES−Pₓ.ES)·CW)/M)). It should be noted that Pₓ.score may represent a summary of the game session performance of a Player X. The winner of the game has the higher score in this example.

Profile update module 250 may be configured to perform database update functions to store calibrated skill vectors and associated context information to corresponding data objects stored in database 220.

Player experience and retention management rule engine 215 may include player retention and remedial actions recommendation rules 255, game session and player recommendation rules 260, and abnormality detection rules 265.

Player retention remedial actions recommendation rules 255 may be used by the system to detect and alert a developer or service provider that a player may be frustrated with a game. For example, the following types of situations may be detected. If the magnitude of the skill vector, SV at time t, of Player X, denoted as Pₓ.SV(t), has dropped below the personal average, Pₓ.SV.avg, by one standard deviation, Pₓ.SV.std (e.g., |Pₓ.SV.avg|−|Pₓ.SV(t)|>|Pₓ.SV.std|), then, the system may send an alert message to a developer or service provider indicating, for example, that player X's skill is dropping below normal, that this is unlikely unless the player is losing more game sessions of different kinds to lower skill players, and that this may be a frustrating experience for player X. Alternatively, if a prediction of the skill vector, P_{y}.SV(t′) (based on k-step predictor on historical data of SV), where t′>t, stays flat or decreases, then, the system may send an alert message to a developer or service provider indicating, for example, that Player Y has not been defeating any better players in the group, and that Player Y may be frustrated about not able to improve his or her playing skills.

Game session and player recommendation rule group 260 may be used to select different types of game sessions or opponent player selection algorithms based on customized criteria. For example, If Player X is frustrated and the player is a VIP (i.e., designated as a very important player, e.g., based on the player's service level or expenditure on game play), the system 200 may invoke a game session selection function to select a game session which includes opponent players having lower average expected scores. Alternatively, if Player X has played the same game for a long period of time (e.g., a predefined or dynamically determined period of time) and Player X's skill has not improved, the system 200 may invoke a game session selection function to select a game session having different game session profiles, (e.g., different weights on attributes), and a set of opponent players having higher average expected scores.

Abnormality detection rule group 265 may be used to filter abnormal patterns based on a predicted trajectory of the SVs. For example, if Player X's skill vector, PlayerX.SV is significantly lower than a predicted SV for Player X, this player may be losing matches that the player would be predicted to have won. If this is the case, the system 200 may determine whether there are network or other impairments impacting the performance of the player. Alternatively, if PlayerX.SV improves significantly at a rate that is greater than normal, the system may then determine whether the skill attributes (e.g., accuracy) of Player X are significantly higher than the most skilled players, e.g., to determine whether Player X is cheating.

Game data storage repository 220 may provide an application programing interface (API) for rule engine 215 to access game data, including game metric data 270, game session profile CWs 275 and player profile SVs 280.

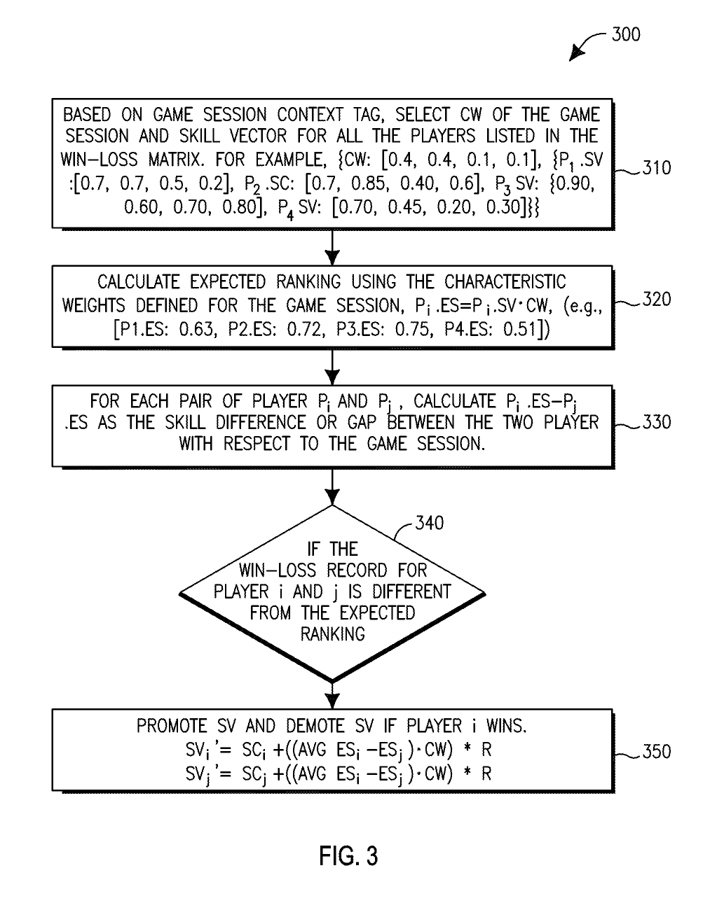

An iterative multiple perspective profiling system may support various implementations in order to provide flexibility for diverse and fast changing game and player types. FIG. 3 is a flow-diagram illustrating an example method 300 for skill vector (SV) projection, ranking, and win-loss calibration. Referring to FIG. 3, in step 310, based on the information contained in a context tag, a subset of skill vectors may be retrieved from the game and player data storage repository 220. The selection criteria may be defined as: Select Player.ID, Player.SV from Player.SVTable, where GameSessionID=ContextTag.GameSessionID and PlayerID in {ContextTag.PlayerList). Such selection criteria may be defined for a player having a given ID (e.g. Player.ID) skill vector (e.g. Player.SV), the skill vector stored in a table of player skill vectors (Player.SVTable), a game session ID (e.g. stored in the Context Tag ContextTag.GameSessionID) and a list of players (e.g. stored in Context Tag, ContextTag.PlayerList).

In step 320, an ES may then be calculated for each player using, for example, a projection of SV to CW. In this example, the projection result reflects that for a player P1 having a skill vector [0.7, 0.7, 0.5, 0.2] playing a game session having a weighted profile [0.4, 0.4, 0.1, 0.1], the expected performance (or ranking) will be 0.63. Example projections of other players P2, P3, P4 may be 0.72, 0.75, and 0.51. In this case, the ranking before play based on the ESs will be, P3>P2>P1>P4.

In step 330, a difference matrix reflecting the difference in ES between each pair of players may be calculated. This matrix may contain the expected difference in performance between players.

On a condition 340 that at least one win-loss record for at least one player is different from a corresponding ES, the calibration process 200 may increase the winners' expected score in step 350. This may be done for each win-loss player pair based on a policy implemented in skill calibration rules. The average ES differences may be prorated by a factor R. The prorated average ES may then be projected to the skill attributes based on the weights of the game session's CW.

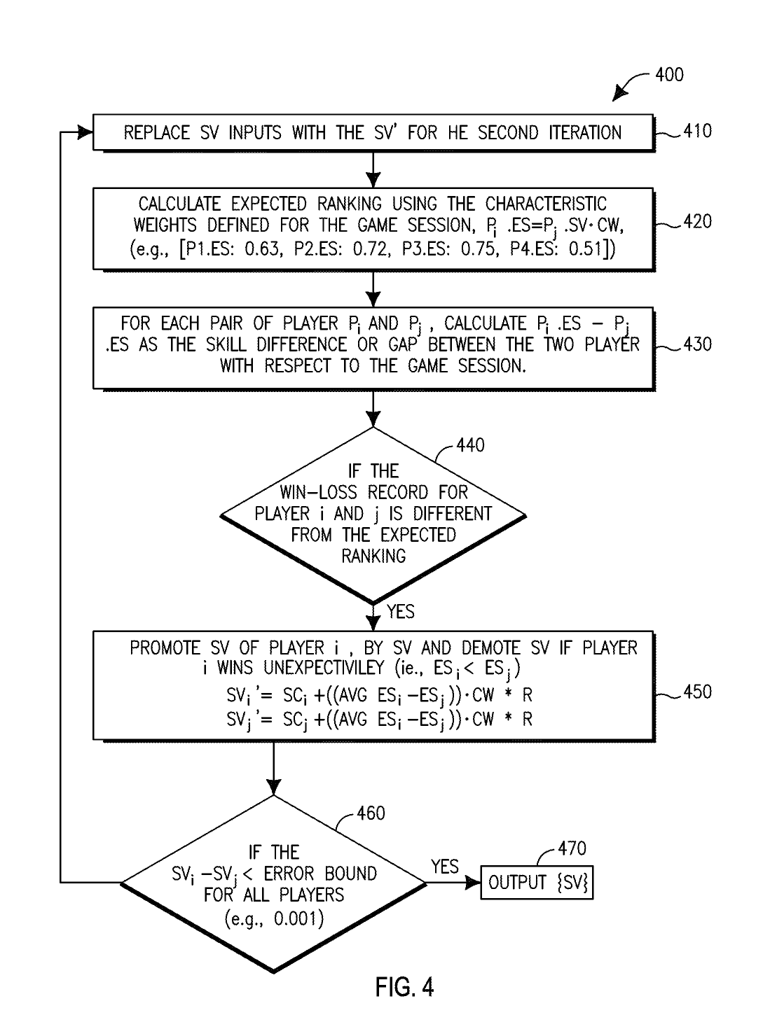

In another embodiment, SVs may be calibrated iteratively, and the results of calibrations may be tracked for player management. FIG. 4 is a flow-diagram illustrating an example method 400 for iterative skill vector calibration. The example method 400 may be used to obtain a set of skill vectors that converges after multiple iterations when applying the same unexpected win-loss outcome to the calibration process.

Example method 400 is similar to method 300 as shown and described with respect to FIG. 3, except in that method 400 may be used for each game session or for multiple game sessions. For example, steps 410, 420, 430, 440, and 450 correspond to steps 310, 320, 330, 340, and 350 respectively as shown and described with respect to FIG. 3.

In method 400 however, for each game session, the calibration process may take the output SVs from step 450, and on a condition 460 that the difference in SV between at least one player pair (player i and player j in this example) exceeds a threshold, may the output SVs back to the input of the calibration process (i.e., step 410) until the SVs fall below the threshold (e.g., 0.001 in this example). If such convergence occurs, the set of SVs are fully calibrated given the unexpected win-loss matrix, and may be output in a step 470. Otherwise, the set of skill vectors are partially calibrated. The calibration process may continue for multiple different game sessions. If the SVs for a set of players have very small standard deviations, the set of SVs may be considered to be a reliable SV (R_SV) set. Players having SVs belonging to an R_SV set may be considered as stable, reliable or persistent players.

A characteristic attributes set that profiles the SVs for games, as described above, may include four basic characteristics, such as reaction time, accuracy, strategy and persistence. The system may support a flexible definition of different sets of characteristic attributes. For example, for games designed to compete on treasure hunting or exploration, explorer characteristics such as [avatar, map, resources, and puzzles] may be modeled. A weight profile may be designed for each game which represents the weighted complexity for different activities. For example, a game that includes high complexity avatar moves and game maps may have a weight profile such as CW={avatar_operation_complexity: 0.3, map_complexity: 0.4, resource_complexity: 0.2, puzzle_quiz_complexity: 0.1}.

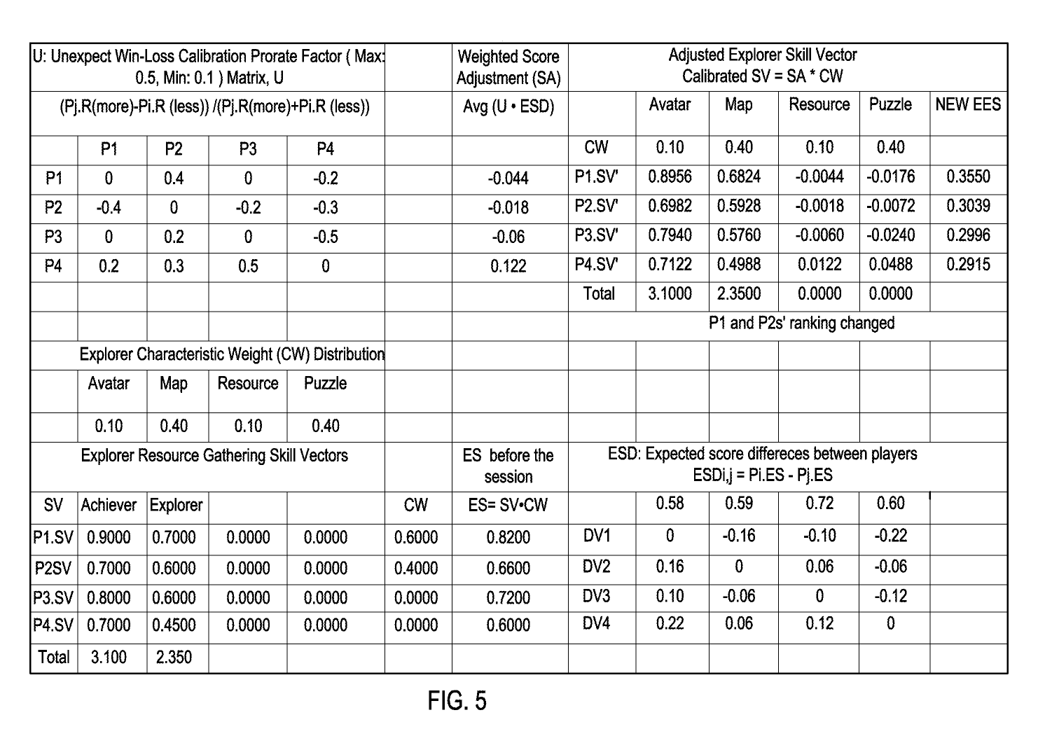

In a treasure hunting or exploration game, for example, the treasure gathering rate of a player may be used as a win-loss indicator to calibrate the explorer skill vector. An example of a resource exploration skill vector may be defined as: SV={avatar_control: 0.8, map_navigation: 0.7, tool_selection: 0.6, puzzle_quiz_solving: 0.8}. FIG. 5 is a matrix illustrating an example set of players P1, P2, P3, P4 having different SVs and playing together in a game session having a profile CW. A set of unexpected win-loss metrics expressed as “U” may be used to represent the condition and prorated factor for unexpected win-loss. The difference matrix may be defined as DV. The expected exploration score for the game session may be defined as, ES=SV·CW. The adjustment of SV=SV+Avg(U·DV). Following the game, the rank for the specific game for players P1 and P2 may be changed. The skill vectors may also be calibrated.

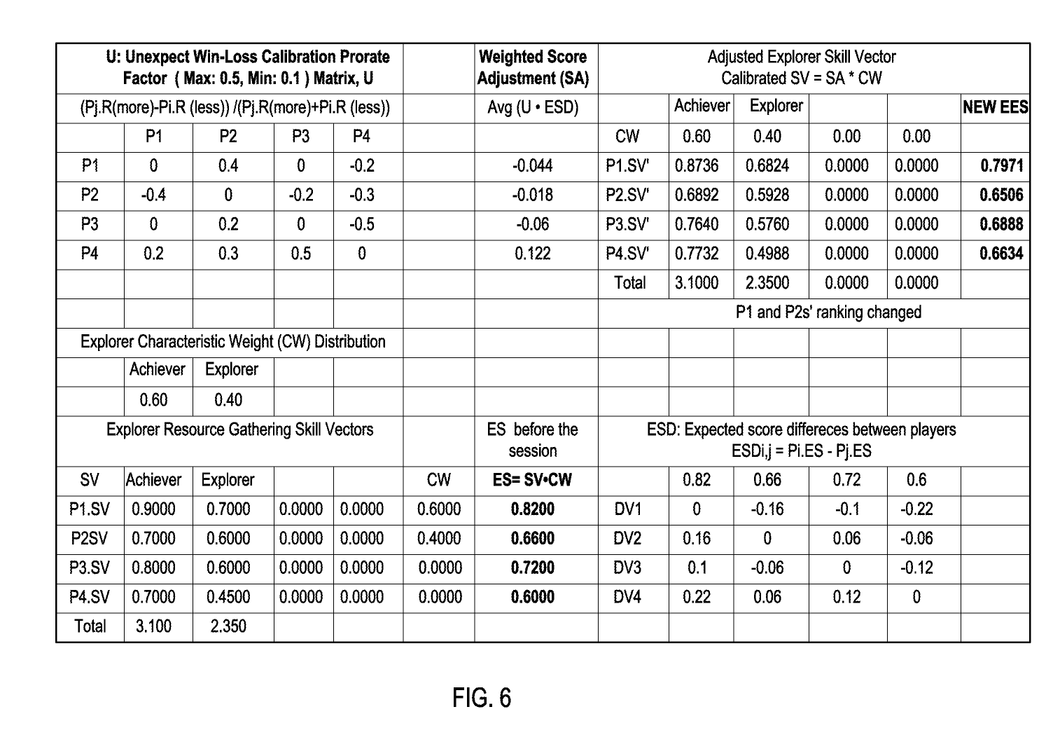

In addition to supporting different characteristic models, a composite characteristic attribute model may also be constructed. For example, as shown in FIG. 6, two independent SVs may be mixed and calibrated based on a game session profile weighting. In this case, the weight is 0.6 for fighter and 0.4 for explorer. After prorated adjustment based on an unexpected win-loss matrix, defined as “U”, the ranking and skill vectors may be adjusted.

In another embodiment, a profiling system may include a skill vector management subsystem that comprises multiple features applicable to the game developer and game hosting service providers. These features may include providing subscription and create, read, update and delete (CRUD) services for game and player profiles, and APIs applicable to SVs for new and existing players and CWs for new and existing game sessions. Per-player based skill vector and game session history and analysis services and APIs may also be provided. Examples of such services may be defined as: 1. [SV(t), . . . , SV(t+k])]←Predict(K_steps, PlayerToken); 2. [CW(t), . . . , CW(t+k)]←Predict(K_steps, PlayerToken); 3. [GameSessionID, MovingAvgSV, STDSV] GroupPlayerStats (Game_Session_List); 4. [MovingAvgSV, STDSV]←PlayerSVStats(PlayerToken). Service 1 predicts skill vector at timestamp t and k following timestamps of a player. Service 2 is similar to service 1 but predicts character weight for players on every timestamp. Service 3 predicts the moving average and standard deviation of skill vector for a particular game session by analyzing a list of previous game sessions. Service 4 predicts the moving average and standard deviation of skill vector for a particular player by analyzing his previous skill vector statistics.

In another embodiment, a cooperative player management platform may allow for “teleportation” (e.g. a player virtual context shift) between game sessions. Such teleportation may be made seamlessly based on a cooperative skill management system. The cooperative player management system may support a characteristic-attribute-based player profile (e.g., skill vectors, preference vectors, or interest vectors), game session profile (e.g., characteristic weights), and a set of services APIs. Cooperative player services may include: game session recommendation services, teleportation services, and game profile calibration services.

Game session recommendation services may be used to retain player interest in bundled games from multiple game developers by providing game session selection services that meet a personalized preference and skill level of the player.

An example API for such services may be described as follows: SessionList=SelectGameSessions(SV, CW, Criteria)//Criteria defines similarity or dis-similarity or specific attributes such as user preference and skill level. Such API may return a list of game sessions that meet a specified criterion.

Game session recommendation services may provide customized game session selection services based on players' preferences on the types of game session CWs. For example, a player may prefer to play in a game session that is focused on combat or treasure hunting. The player may select a candidate game session's CW (GS.CW), based on distance from a preferred characteristic weight profile (Prefer.CW) as specified by the player or the system. For example, a player may select game session based on the following criteria: (1) (Prefer.CW·GS.CW)/∥Prefer.CW∥ ∥GS.CW∥>0.9; (2) (Prefer.CW·GS.CW)/∥Prefer.CW∥ ∥GS.CW∥<0.5; or (3) Select CW.accuracy>0.5 and CW.strategy<0.2. These criteria compare the preferred characteristic weight (Prefer.CW) with characteristics weight of candidate game session (GS.CW). In criteria 1, the similarity between Prefer.CW and GS.CW is required to be larger than 0.9 (the range of similarity is from 0 to 1). Criteria 2 requires the similarity to be smaller than 0.5. For criteria 3, the requirement for particular element in CW can be specified such as accuracy and strategy of CW can be require to be larger than 0.5 and smaller than 0.2 respectively.

Game session recommendation services may also recommend game sessions based on a k-step predictor. This function may allow players to preview the types of the game sessions that are likely to fit the players interests based on play history and the player history of other players who have similar skill vectors as the player. The proposed predictive game session selection criteria may be described as follows:

The first criteria may be to use k step predictor to calculate the recommended game sessions' CWs for Player X, (e.g., Pₓ.CW(t+1), . . . , Pₓ.CW(t+k)) based on a set of play history: {Pₓ.CW(t−5), Pₓ.CW(t−4) . . . Pₓ.CW(t)};

The second criteria may be to use k step predictor to calculate the recommended game session based on impressions from other players e.g., (Player Y), with skill vector match Player X: {P_{y}.CW(t−5), P_{y}.CW(t−4) . . . P_{y}.CW(t)};

The third criteria may be to analyze and select game sessions with compatible player group using k step predictor to calculate Pₓ.SV(t+k) based on: {Pₓ.SV(t−5), Pₓ.SV(t−4) . . . Pₓ.SV(t)}. Then, find the game sessions with a player group that has a mean ES that matches that of the Pₓ.ES=Pₓ.SV(t+k)·Pₓ.CW(t+k). For example, the mean expected score of the set of players in the selected game session, Avg(ESᵢ)(e.g., Average((Pᵢ.SV)·CVⱼ) for i=1, m and j=1, 4) is closest to Pₓ.ES(t+k).

The first criteria uses the historical Characteristic Weights, CWs of the game session played by Player X before timestamp t to predict CWs of games session that may be of interest to Player X in the future timestamps (t+1 to t+k). The second criteria uses historical CWs of games played by another Player Y whose skill vector is similar to Player X's skill vector to predict CWs of game sessions for Player X. The third criteria uses the historical skill vector, SVs to predict the future skill vector of Player X. Then, find a game session with average expected score of players in the game session that is compatible with Player X's expected score.

Teleportation services may be provided to allow teleportation to a new game session while retaining experience and resources acquired from previous games in order to continue play in a game bundle or in a game hosting platform supporting multiple game bundles. Example resources may include points collected from a previous game, an energy level, weapons or treasures, and so forth. The API may be defined as: SessionTeleport(PlayerToken, Game.session.ID, SV, Resource_Container). The Resource_container may provide a reference to the resources the player has gathered. New game sessions may verify the compatibility of the new resources to decide if the resources can be used in the new game session. For example, the player's score, energy level and shield may be compatible with the new session while some other resources may not be recognized. The player's SV and Game session's CWs may be obtained from the session and player selection service. The PlayerToken may be needed to authorize the loading and consumption of resources from one session to another.

Players within a team may teleport to different games or different parts of the games. The different games or different parts of games that the players teleport into may require different mixes of skills. The profiling system may support fast skill vector and game session CW statistic summaries for team leaders or players to teleport to areas that may best match the players' strengths described in skill vectors.

Game profile calibration services may be provided to allow the game developer to select a set of players with minimal standard deviation (SV.STD) on different characteristic attributes or skill vectors. Using this set of players with stable SVs, i.e., consistent players, the game designer may calibrate the difficulty level and CW of the game session. For example, if the score of a set of consistent players with reaction time and accuracy attributes is consistently lower than the desired level of the game session, the game may be too difficult. For example, if players with high exploration skill vectors are not able to find a treasure in an expected amount of time, the game session map design may be too complicated. In another example, if the players with high fighting skill level and low exploration skill consistently are winning an exploration game with exploration at a higher weight, the game weights may needs to be adjusted.

The SVs and CWs of different game sessions may be applied to games that are divided into multi-rooms or areas and played with teammates. The skill vectors of players within the team may be aggregated and analyzed to support the assignment of players with different skills for different tasks (e.g., fighting, or hunting).

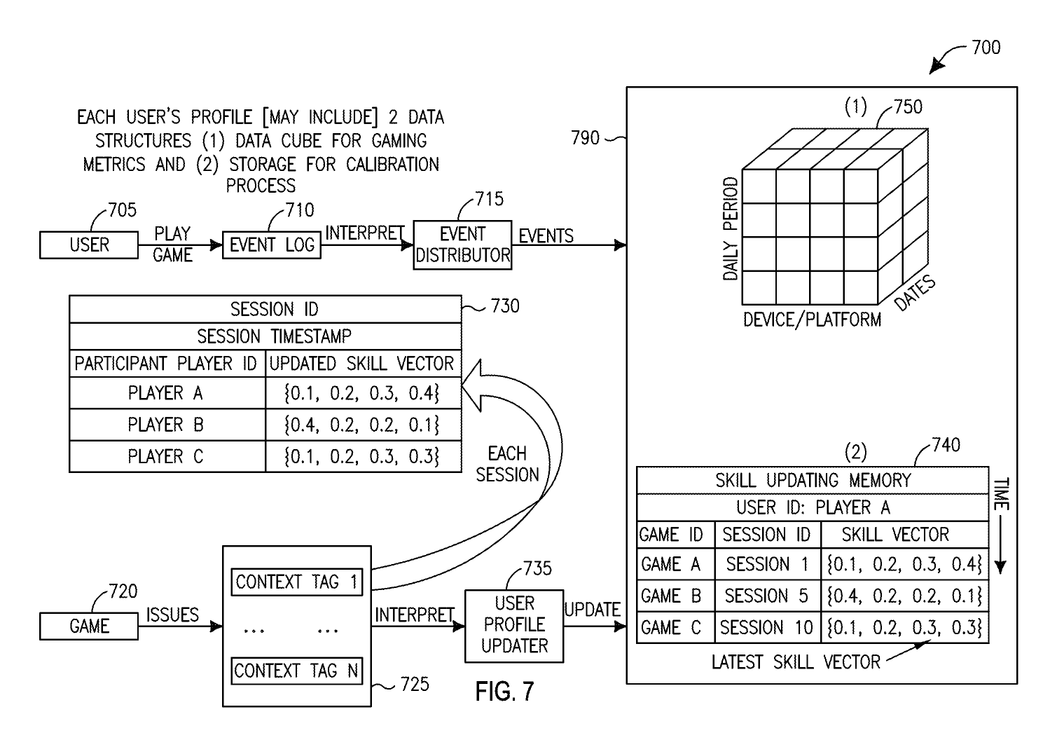

FIG. 7 is a diagram of an example model 700 of a profiling system. In the example model 700, a user profile 790 may be generated using profiling data, which may be obtained from user-side events, and app-side gaming sessions issued by game server.

User-side events may be generated during gaming. When a user 705 plays a game, they may generate a series of traceable events, which may be cataloged in an event log 710. Each event may carry parameters, for example, Game ID, Account ID, Device/platform and/or other specific information. An example event log with detail of traceable events is shown in Table 3, below. The event log 710 may be interpreted by an event distributor 715 to be distributed to an appropriate data cube 750, as will be described further herein. Once the event is distributed to the correct data cube, the event may be parsed to update a relevant profile document.

App-side gaming sessions may be issued by a game server. Each game 720 may issue many sessions 725 for players to compete with other players or AI bots. At the end of each session, the profiling system may store session results in a session log 730. Each session result may include the following information: session ID, timestamp, participant players, and their adjusted skill vector value as a result of the session. A historical list of context tags may be obtained from this data. A user profile updater 735 may be used to interpret each session result in the session log 730, determine relevant players, and update their skill vector in skill updating memory 740.

Traceable events may be generated by users when they are gaming. A timestamp and other information may be used for game providers to trace users' gaming behavior and interpret their gaming experiences and satisfaction. Traceable events, as reflected in Table 3 above, may include most aspects of users' in-game behavior. However, this table is not meant to be all-inclusive and may be extended based on the characteristics of specific games, for example.

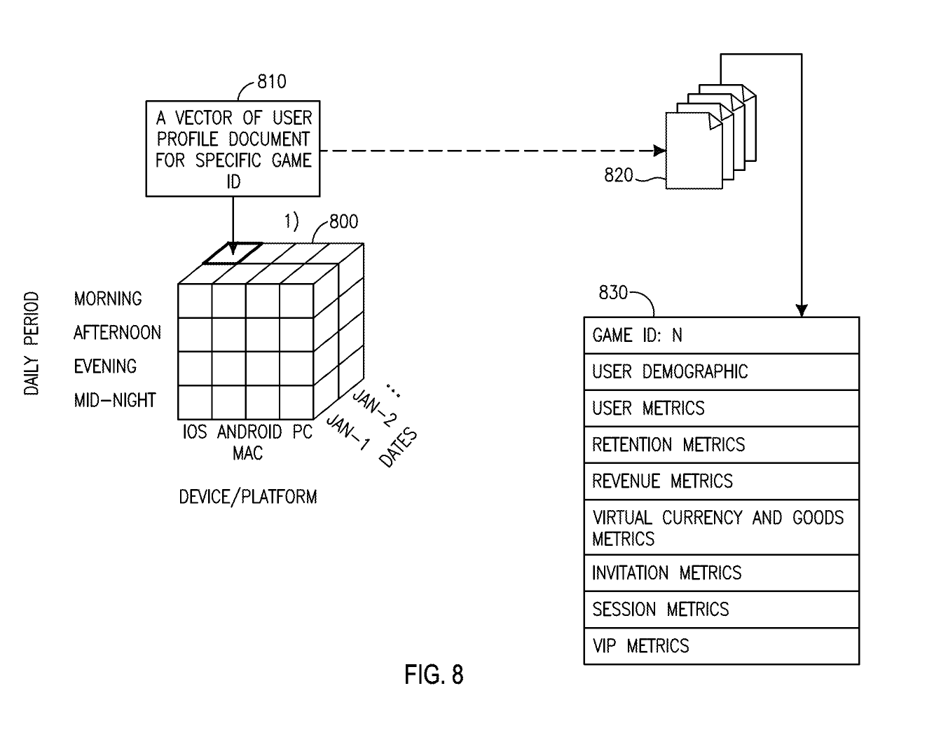

FIG. 8 is a diagram of an example data cube 800 for game metrics, session context and user profiles. The example data cube 800 may be used to store user gaming metrics. Such user gaming metrics may be parsed from the events log 710 as described above regarding FIG. 7. Each user may use a single data cube. In an alternative embodiment, a user may have more than one data cube. Each data cube may have 3 dimensions: device/platform, date and daily time period. Each element of the data cube may hold a vector 810 of profile documents 820. Each document may store a metrics table 830 of a specific game which includes aspects of gaming metrics for a specific device, date and daily time period. When a user generates event logs, the events may be interpreted and distributed to a specific place in the user's data cube and profile document having a specific Game ID. The event may then be parsed in order to update the metrics. A table of example metrics for monitoring and evaluating users' gaming experiences and satisfaction is depicted in Table 4, below.

An example calibration process for an input data stream of trace user's skill vector records is discussed further herein. A data stream may be processed dynamically on the fly using processing rules based on calibration and aggregation policies. The processing results, such as moving average or standard deviations, or k-step predictions, may be stored in a memory as well as a history log. The SVs and CWs are one example of the stream data that may be processed by the rules. The resulting statistical data may be stored in the data cube for fast retrieval. For example, the CW prediction for a user may be used by a game session selection rule. The SV of a player may be used to match players.

The calibration process may also be varied. The system may support multiple types of processing rules to support diverse game types and player characteristics. Rules may be added to the calibration process to make the system more adaptive. Also, the calibration process may be enhanced to allow users to specify a play mode. Play modes may be added to support special conditions to change the calibration process. For example, a player may decide not to be rated when she is not feeling well.

The skill adjustment may use low prorate factors at first, and increase the gradient until a limitation is reached, so that unexpected losses do not reduce the skill vector to a level that may frustrate a player with higher ranks. In this way, the system may be stable and check the real gaming ability of players. For example, the following options may be available: Players' promote/demote skill vector may be factored. First 5 sessions, 2%. Then increase 1% each time, until a limitation of 20% is reached.

Where player is not in a condition to play, e.g., the player is sick, the player may opt out of the skill vector calibration by changing a play mode. The system may be configured to offer the player several rounds of gaming in which the system will not demote their skill based on an unexpected loss. Later, the calibration process may be resumed. For example, players may have the option to avoid the calibration system, and may play with other players who have also chosen to avoid the calibration system. In another example, each player may have 5 rounds of gaming where skill points will not be demoted due to an unexpected loss. However, the system may generate extra points for those lower rank winning players for promotion. In this way, players' ranks will not be affected largely by players employing unusual gaming modes.

When a new player is subscribed to user management services, the system may provide an initial SV and the player may adjust the initial SV based on self-assessment. For example, the system may give each new player an initial skill vector {0.5, 0.5, 0.5, 0.5}, and the players may adjust this by their own self-assessment.

The profiling system may also collect all the skill vectors generated from the calibration processes for each win-loss in a memory to calculate moving averages and standard deviations and predictions on the fly. The statistical data may be stored in the data cube with the time, location and device information. For example, the system may track players' SVs in an average and standard deviation in order to determine abnormal activities.

The SV may also have multiple modes for players having different interests e.g., achievement, exploring, etc. For example, the system may support additional player characteristic attributes for the following skill vectors shown below in Table 5.

TABLE 5
Additional Player Characteristic Attributes Skill Vector

| Skill | |
|---|---|
| attribute | Description |
| Strategy | The user can select the best strategy in the game. |
| Reaction | The user can react to the opponents and environment in a |
| | short time. |
| Accuracy | The user can complete an action or control his virtual |
| | character accurately. |
| Persistence | The user has the patience to explore the virtual world or |
| | stay in the game. |
| Familiarity | The user is familiar with the virtual item and map in a |
| | way which provides an advantage. |
| Memory | The user is capable of memorizing the actions or positions |
| | of his opponents or AT, which may be useful e.g., in a card |
| | game. |
| Self-adaption | The user is able to adapt to a sudden change or poor |
| | situation. The user is able to find a solution to reverse the |
| | game result. |
| Teamwork | The user is able to play with a teammate and gain a team |
| | advantage. |

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A method performed by a server for dynamically adjusting a user profile stored on the server and utilized by a plurality of applications run on a plurality of user devices connected to the server over a network, the method comprising:
determining a user vector which includes a plurality of user attributes including at least one user skill attribute characterizing a user based on one or more interactions that the user has with another user or an Artificial Intelligence (AI);
determining a characteristic weight vector which includes a plurality of characteristic weights characterizing an application of the plurality of applications, wherein at least one of the plurality of characteristic weights corresponds to one of the at least one user skill attribute; and
generating an observation based on the user vector and the characteristic weight.

2. The method of claim 1, wherein the observation comprises a projected result of an execution of the application.

3. The method of claim 2, further comprising:
determining an actual result of the execution of the application; and
on a condition that the actual result differs from the projected result by a threshold, updating the at least one user skill attribute.

4. The method of claim 1, further comprising adjusting the at least one user skill attribute dynamically based on application or user data generated during an interaction by the user with the application.

5. The method of claim 4, wherein the application or user data comprises in-application metrics or win/loss statistics.

6. The method of claim 1, wherein generating the observation comprises projecting the user vector and the characteristic weight vector.

7. The method of claim 1, wherein the observation comprises a compatibility of the user with the application.

8. The method of claim 1, wherein the observation comprises a compatibility of the user with another user.

9. The method of claim 1, wherein the observation comprises an abnormal event within the application.

10. The method of claim 1, wherein the user vector characterizes at least one skill, interest, or preference of the user.

11. A server configured to dynamically adjust a user profile for bundled applications, the server comprising:
a processor and a non-transitory computer readable medium in communication with the processor; wherein the processor comprises:
circuitry configured to determine a user vector which includes a plurality of user attributes including at least one user skill attribute characterizing a user based on one or more interactions that the user has with another user or an Artificial Intelligence (AI);
circuitry configured to determine a characteristic weight vector which includes a plurality of characteristic weights characterizing an application, wherein at least one of the plurality of characteristic weights corresponds to one of the at least one user skill attribute; and
circuitry configured to generate an observation based on the user vector and the characteristic weight.

12. The server of claim 11, wherein generating the observation comprises projecting a result of an execution of the application.

13. The server of claim 12, further comprising:
circuitry configured to determine an actual result of the execution of the application; and
circuitry configured, on a condition that the actual result differs from the projected result by a threshold, to update the at least one user skill attribute.

14. The server of claim 11, further comprising circuitry configured to adjust the at least one user skill attribute dynamically based on application or user data generated during an interaction by the user with the application.

15. The server of claim 14, wherein the application or user data comprises in-application metrics or win/loss statistics.

16. The server of claim 11, wherein generating the observation comprises projecting the user vector and the characteristic weight vector.

17. The server of claim 11, wherein the observation comprises a compatibility of the user with the application.

18. The server of claim 11, wherein the observation comprises a compatibility of the user with another user.

19. The server of claim 11, wherein the observation comprises an abnormal event within the application.

20. The server of claim 11, wherein the user vector characterizes at least one skill, interest, or preference of the user.
